(19) United States
(12) Patent Application Publication
(10) Pub. No.: US 2013/0015818 A1
(43) Pub. Date: Jan. 17, 2013

(54) CIRCUIT ASSEMBLY

(71) Applicant: Tim Schaefer, Harztor (DE)

(72) Inventor: Tim Schaefer, Harztor (DE)

(73) Assignee: Li-Tec Battery GmbH, Kamenz (DE)

(21) Appl. No.: 13/578,263

(22) PCT Filed: Jan. 19, 2011
(86) PCT No.: PCT/EP11/00203

§ 371 Date: Oct. 3, 2012

(30) Foreign Application Priority Data
Feb. 15, 2010 (DE) 10 2010 008 010.1

(51) Int. Cl. H02J 7/00

(52) U.S. Cl. 320/119

(57) ABSTRACT

The invention relates to a circuit assembly (10), comprising a series connection of first and second battery units (11, 12), wherein first and second battery units (11, 12) are arranged alternately, a first inductive storage element (13), wherein in a primary phase first inputs (17) of the first battery units (11) can be connected to a first terminal (19) of the first inductive storage element (13) by means of a first switch assembly (16) and second inputs of the second battery units (18) can be connected to a second terminal (20) of the first inductive storage element (13) by means of the first switch assembly (15), a second inductive storage element (14) which is inductively coupled to the first inductive storage element (13), wherein in a secondary phase by means of a second switch assembly (16) a first terminal of the second inductive storage element (14) can be connected to a first or a second input and a second terminal of the second inductive storage element (14) can be connected to a second or a first input.

The invention relates to a circuit arrangement, particularly a circuit arrangement for exchanging electrical charge between battery units of a battery arrangement, and also a battery management system with a circuit arrangement of this type.

DE 10 2008 021 090 A1 shows a circuit arrangement for exchanging electrical charge between rechargeable batteries of a rechargeable battery arrangement which has a number of rechargeable batteries connected in series. A charging current can be supplied to the rechargeable battery arrangement. A discharge current can be drawn from the rechargeable battery arrangement. In this case, different charging states of individual rechargeable batteries can occur within the rechargeable battery arrangement. To compare such unequal charging states, an inductive storage element is assigned to each rechargeable battery in the circuit arrangement shown, wherein a switching element is provided between the rechargeable battery and the inductive storage element. A second inductive storage element is inductively coupled to the first inductive storage elements. In a first operating mode, the switching elements arranged between the first inductive storage elements and the rechargeable batteries belonging thereto are closed, so that energy, which is transmitted via the first inductive storage element to the second inductive storage element, is drawn from the rechargeable batteries. By means of corresponding closing of individual closing of individual switching elements which are arranged between first inductive storage elements and the respective rechargeable batteries, energy present in the second inductive storage element can be transmitted in a targeted fashion to an individual or to a plurality of rechargeable batteries. Overall, a redeployment of energy from rechargeable batteries to other rechargeable batteries can be undertaken hereby. This is used to balance the rechargeable batteries.

The present invention is based on the object of providing an improved circuit arrangement for balancing battery units, particularly battery units connected in series.

The object upon which the invention is based, is therefore achieved by means of a circuit arrangement according to claim 1. Preferred embodiments result from the sub-claims.

According to the invention, a circuit arrangement is provided, which comprises a series connection of first and second battery units, wherein first and second battery units are arranged in an alternating manner. The first and second battery units can be identical in each case. The difference between the first and second battery units lies, as will be shown, predominantly in the respective different wiring. A battery unit can comprise one or a plurality of electrochemical cells.

Further, a first inductive storage element is provided. In a primary phase, first inputs of the first battery units can be connected to a first connector of the first inductive storage element via a first switch arrangement. Second inputs of the second battery units can be connected to a second connector of the first inductive storage element via the first switch arrangement. A second inductive storage element is provided, which is inductively coupled to the first inductive storage element. An inductive coupling is in this case understood as meaning that a magnetic field and a magnetic flux can be transmitted from the one inductive storage element to the other inductive storage element. This can preferably be undertaken by means of a transformer core. The first and the second storage elements can be constituents of a common transformer unit.

In a secondary phase, a first connector of the second inductive storage element can be connected to a first or a second input and a second connector of the second inductive storage element can be connected to a second or a first input by means of a second switch arrangement. The person skilled in the art can see that on account of the series connection of the battery units, an input of a battery unit can at the same time constitute an output of the battery unit connected upstream in series. Thus, an input of a second battery unit can constitute an output of a first battery unit and vice versa.

A battery unit preferably comprises an electrode stack which, as module of a galvanic cell, is also used for storing chemical energy and for emitting electrical energy. To this end, the electrode stack has a plurality of plate-shaped elements, at least two electrodes, namely an anode and a cathode, and a separator which accommodates the electrolyte at least to some extent. Preferably, at least one anode, a separator and a cathode are laid or stacked one above the other, wherein the separator is at least to some extent arranged between anode and cathode. This sequence of anode, separator and cathode can repeat as often as desired within the electrode stack. Preferably, the plate-shaped elements are wound up to form an electrode winding. In the following, the term “electrode stack” is also used for electrode winding. Before emitting electrical energy, stored chemical energy is converted into electrical energy. During charging, the electrical energy supplied to the electrode stack is converted into chemical energy and stored. Preferably, the electrode stack has a plurality of electrode pairs and separators. Particularly preferably, some electrodes are interconnected, particularly electrically connected to one another.

By means of the circuit arrangement according to the invention, it is possible to draw energy from a battery unit in a targeted fashion and to temporarily store the same particularly in the first inductive storage element, specifically in magnetic form. This magnetic energy can then be transmitted by means of the inductive coupling to the second inductive storage element. Depending on the connection of the second switch arrangement, the magnetic energy of the second inductive storage element can be transmitted to the first or second battery units. Whether the magnetic energy should be transmitted to first or to second battery units is fundamentally determined depending on the position of the second switch arrangement. It is then possible to determine to which individual battery unit precisely this energy should be transmitted on the basis of the position of the first switch arrangement in the secondary phase. It is advantageous in this case that it is possible to use a first and second inductive storage elements for the balancing procedure with respect to a plurality of battery units. The provision of a plurality of inductive storage elements which are in each case assigned to only one battery unit can be dispensed with so that a simplified structure can result.

By means of the circuit apparatus according to the invention, differences in charging states between the battery units can be exchanged via an individual transformer. The switch devices can in this case be formed by means of MOSFETs. By means of the targeted, microcontroller-controlled actuation of these switch devices, any flow direction of energy from any desired battery unit to any desired other battery unit can be produced.

Preferably, inputs of a battery unit are in each case directly connected to one output of a respectively upstream-connected battery unit, particularly two inputs of second battery units are in each case directly connected to first outputs of first battery units. As a result, the circuit arrangement can be simplified. Switches of the switch arrangement, which are used for controlling the first battery units, can then also be used for wiring second battery units. Overall, as a result, the number of switches can be reduced and/or the structure of the circuit arrangement can be simplified.

Preferably, in this case first inputs can be connected using first intermediate switches and second inputs can be connected using second intermediate switches to the first inductive storage element. The first and second intermediate switches are preferably identical in this case and may only be differentiated by means of the position thereof within the circuit arrangement on the first or the second battery units. In this case, the second intermediate switches can be connected to the second connector and the first intermediate switches can be connected to the first connector of the first inductive storage element. The first and second intermediate switches are constituents of the first switch arrangement.

The second switch arrangement is in particular used for determining whether the energy, which may be stored in magnetic form in the first or second inductive storage element, should be transmitted to first or to second battery units. In other words, one input of a battery unit is converted to an output for the following charging process by means of the second circuit arrangement. In this case, the second switch arrangement preferably has a third intermediate switch and a fourth intermediate switch, which in particular can also be constructed by means of a one-piece switch. Depending on the position of this switch, a connector of the storage element is in each case connected to the inputs or the outputs of first or second battery units. Preferably, the second switch arrangement can also be expanded by means of fifth and sixth intermediate switches which can connect or separate the respective other connector of the second inductive storage element to a corresponding input or output or a plurality of the same of the battery units. The third and the fifth or the fourth and the sixth intermediate switches can in each case preferably be switched synchronously with one another. The second switch arrangement is in this case preferably also used fundamentally for the complete separation of the second inductive storage unit with all of the inputs or outputs of the battery units.

Preferably, a charging switch is connected in series upstream of the first inductive storage element. The same can in particular be connected in series directly upstream of the first inductive storage element. This charging switch can be used for a fundamental separation of the first inductive storage element from a circuit in which the first inductive storage element can be arranged. Thus, any current flow between the first inductive storage element and the battery units can preferably be suppressed, which is of particular importance in the secondary phase.

The first inductive storage element and the second inductive storage element are preferably constructed in the form of electromagnetic coils. In this case, the electromagnetic coils in each case have a number of windings. A winding ratio N₁/N₂ of windings of the first inductive storage element to windings of the second inductive storage element is in this case preferably greater than or equal to 1, particularly slightly greater than 1, namely in particular between 1.05 and 1.5, particularly between 1.05 and 1.1. By means of this choice of the winding ratio, efficiency losses can be compensated and a charging process for a target battery unit, which may also have a relatively low voltage, can be triggered. Ohmic voltage drops at contact and transfer resistances can be overcome.

Preferably, inputs, particularly all first and second inputs, are connected to at least one voltage measuring device. The voltages present at the individual battery units can be determined via the voltage measuring device or at least conclusions about the voltage at the individual battery units can be drawn. The determined voltages can enable conclusions about the charges stored in the battery units, as is also described in DE 10 2008 021 090 A1.

Preferably, the first and/or second inductive storage device is connected to a voltage measuring device. The voltage measuring devicecan preferably be directly connected to the two connectors of the first inductive storage device. Using the voltage which can be measured therewith, conclusions can be drawn about the inductive charging state of the respective inductive storage device. This is advantageous in order to draw the most optimal energy possible from a battery unit for charging the inductive storage device, which energy can then in turn be supplied via the second inductive storage device to another battery unit. As a result, the efficiency of circuit arrangement can be increased.

The invention further relates to a battery management system comprising a circuit arrangement of the type mentioned previously.

The invention is explained in more detail on the basis of the following figures, in which:

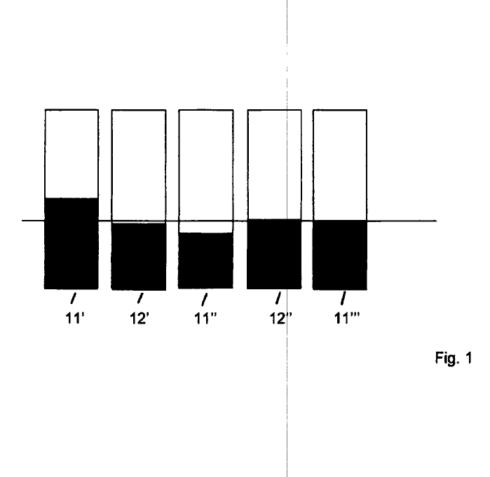

FIG. 1 schematically shows the charging state of the battery units before a balancing process is started;

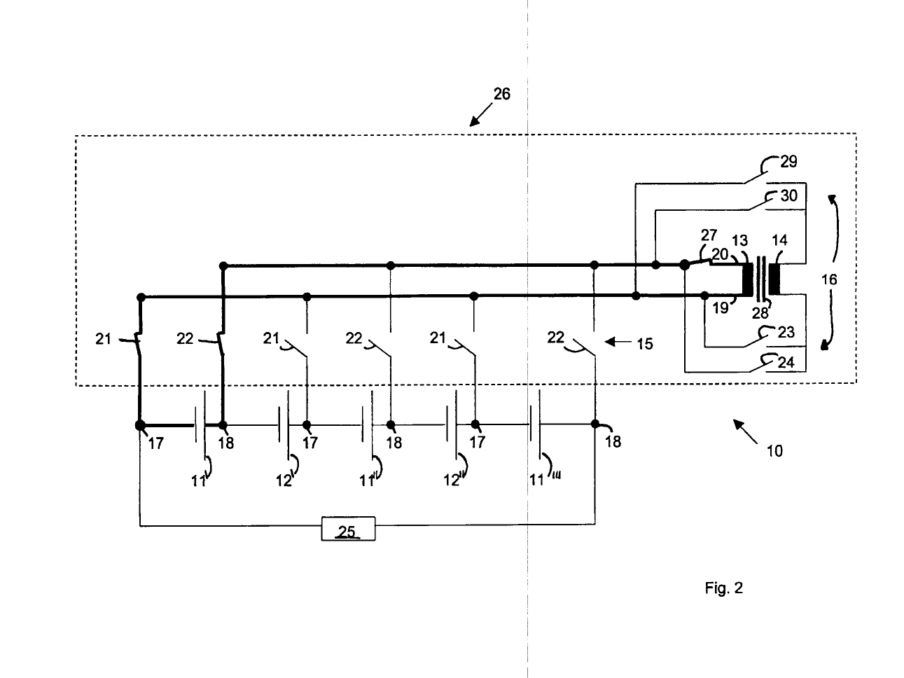

FIG. 2 shows the circuit diagram of a circuit arrangement according to the invention in a primary phase;

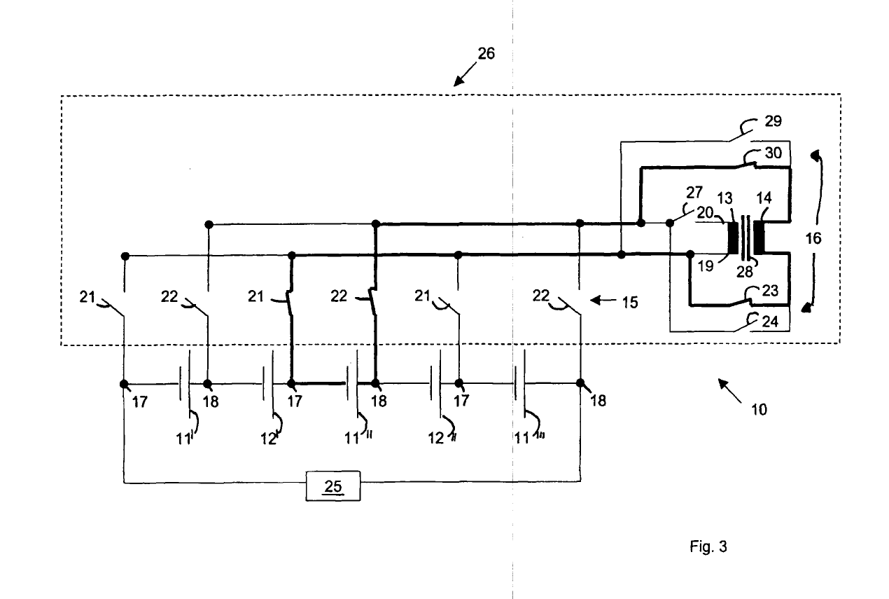

FIG. 3 shows the circuit diagram of a circuit arrangement according to the invention in a secondary phase;

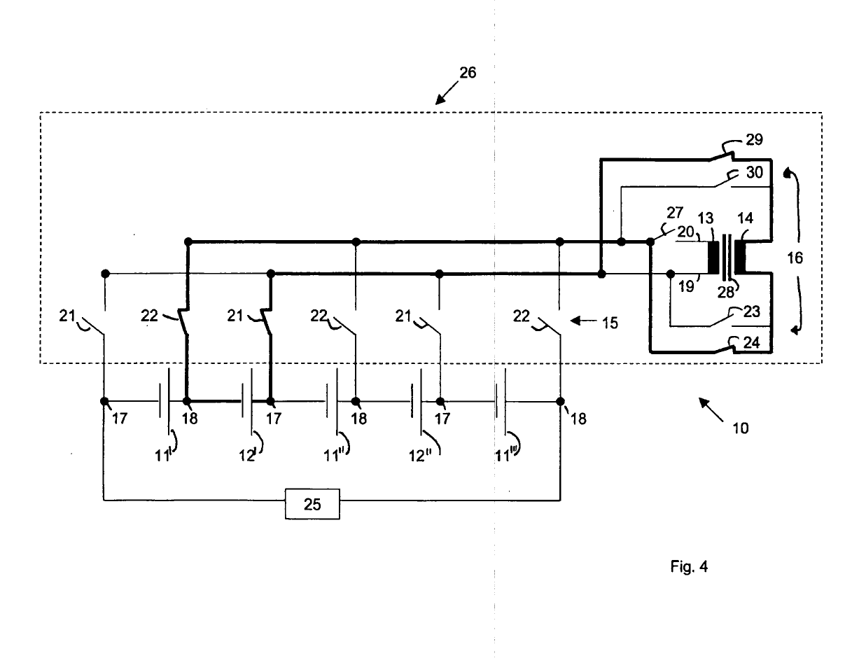

FIG. 4 shows the circuit diagram of a circuit arrangement according to the invention in an alternative secondary phase;

FIG. 1 schematically shows the charging state of five battery units 11, 12 which are arranged in a battery arrangement with a plurality of battery units. The horizontal line in this case marks the average charging state over all five battery units. It can be seen that the left battery unit 11′ has a higher charging state than all of the remaining battery units. The central battery unit 11″ has a lower charging state than all of the remaining battery units. In order to compare all of the battery units with one another, it is necessary that the charging quantity at the left battery unit 11′ which is above the average be transmitted to the central battery unit 11′. This is realised by means of a circuit arrangement which is explained on the basis of the following figures.

FIG. 2 shows a circuit arrangement 10 according to the invention in a primary phase, in which electrical energy is drawn from a battery unit 11′ in order to supply this energy in a subsequent secondary phase to another battery unit 11″. The circuit arrangement 10 shown comprises a plurality of battery units 11, 12 which are connected in series. An application circuit 25 is connected to the series circuit of the battery units. This application circuit 25 can have electrical consumers, particularly all electrical consumers which may be possible in a vehicle, such as an electric motor for drive or the like. Further, a charging process of the battery unit is undertaken via the application circuit. The first battery units 11 and second battery units 12 are structurally identical. An input 17, 18 is assigned to each battery unit 11, 12, wherein a first input 17 is assigned to the first battery units 11 in each case and a second input 18 is assigned to the second battery units 12 in each case. It can be seen that the inputs 18 of the second battery units 12 generally correspond to the outputs of the first battery units 11 and the inputs 17 of the first battery units 11 correspond to the outputs of the second battery units 12, with the exception of battery units located at the outer edges. The inputs 17, 18 of the battery units are connected to connectors 19, 20 of a first inductive storage element 13 via a first switch arrangement 15. In this case, a first intermediate switch 21 of the first switch arrangement 15 is connected to a first connector 19 of the first inductive storage element 13. A second intermediate switch 22 of the first switch arrangement 15 is connected to a second connector 20 of the first inductive storage element 13. The circuit arrangement 10 is a constituent of a battery management system 26.

In FIG. 2, the circuit arrangement 10 is illustrated in a primary phase in which the excess energy from the left battery unit 11′ is used to charge up the first inductive storage element 13. In this case, the corresponding first and second intermediate switches 21, 22 at the left battery unit 11′ are closed so that a circuit forms which connects the left first battery unit 11′ to the first inductive storage element 13. A charging switch 27, which is connected directly upstream of the first inductive storage element 13, is closed. All of the other switches of the circuit arrangement 10 shown are open.

FIG. 3 shows the circuit arrangement 10 according to FIG. 2 in a secondary phase which follows with respect to the primary phase shown in FIG. 2. It can be seen that the intermediate switches 21, 22 which connect the left first battery unit 11′ to the first inductive storage element 13 are open so that this battery unit 11′ is no longer connected to the first inductive storage element 13 in a common circuit. Rather, first and second intermediate switches 21, 22 are open with respect to the central battery unit 11″ which, as already stated with respect to FIG. 2, should be supplied with excess energy from the left battery unit 11′. Further, it can be discerned that the charging switch 27 is open so that the first inductive storage element 13 is completely decoupled. In the present secondary phase, a second inductive storage element 14 is used, which can be connected to one or a plurality of battery units 11, 12 via a second switch arrangement 16 and the first switch arrangement 15. The second switch arrangement 16 has fourth to seventh intermediate switches 23, 24, 29, 30 which can connect the connectors of the second inductive storage element 14 to the respective switches 21, 22 which are assigned to the inputs or outputs of the battery units. The first inductive storage element 13 is connected by means of a transformer core 28 to the second inductive storage element 14. The first inductive storage element 13, the second inductive storage element 14 and also the transformer core 28 together form a transformer.

In the secondary phase shown, the fourth intermediate switch 24 and also the sixth intermediate switch 30 are open so that a circuit is produced between the central battery unit 11″ and the second inductive storage element 14. The stored energy of the second inductive storage element 14 can then be transmitted to the central battery unit 11″.

In a deviation from the secondary phase shown in FIG. 3, FIG. 4 shows an alternative secondary phase in which, instead of the central first battery unit 11″, a second battery unit 12′ is additionally supplied with energy by means of the circuit arrangement 10. It can be seen that a current must then flow in a different direction via the intermediate switch 21 than was the case with respect to FIG. 3. The second switch arrangement 16 in this case ensures that the outputs of the second inductive storage element 14 are then arranged inversely to the inputs or outputs of the second battery unit of the battery unit 12 to be charged. To this end, instead of the fourth and the sixth intermediate switches, the third and the fifth intermediate switches 23, 29 are closed. Further, the first and second intermediate switches 21, 22, which are directly assigned to the left second battery unit 12′ to be charged, are closed. Otherwise, the circuit arrangement 10 remains unchanged compared to FIG. 3.

### REFERENCE LIST

10 Circuit arrangement

11 First battery unit

12 Second battery unit

13 First inductive storage element

14 Second inductive storage element

15 First switch arrangement

16 Second switch arrangement

17 Inputs of the first battery unit

18 Inputs of the second battery unit

19 First connector of the first inductive storage element

20 Second connector of the first inductive storage element

21 First intermediate switch

22 Second intermediate switch

23 Third intermediate switch

24 Fourth intermediate switch

25 Application circuit

26 Battery management system

27 Charging switch

28 Transformer core

29 Fifth intermediate switch

30 Sixth intermediate switch

1. A circuit arrangement comprising:
a series connection of first and second battery units, wherein first and second battery units are arranged in an alternating manner;
a first inductive storage element; and,
a second inductive storage element, which is inductively coupled to the first inductive storage element,
wherein in a primary phase, first inputs of the first battery units are connected to a first connector of the first inductive storage element via a first switch arrangement and second inputs of the second battery units are connected to a second connector of the first inductive storage element via the first switch arrangement, and
wherein in a secondary phase, using a second switch arrangement
a first connector of the second inductive storage element is connected to a first input of a first battery unit and a second connector of the second inductive storage element is connected to a second input of a second battery unit.

2. The circuit arrangement according to according to claim 1, wherein the inputs of the second battery units are connected to an output of a first battery unit, respectively.

3. The circuit arrangement according to claim 1, wherein first inputs are connected using first intermediate switches and second inputs are connected using second intermediate switches to the first inductive storage element.

4. The circuit arrangement according to claim 1, wherein the second switch arrangement comprises third intermediate switches and fourth intermediate switches.

5. The circuit arrangement according to claim 1, wherein the second switch arrangement comprises fifth and sixth intermediate switches, and third and fifth or fourth and sixth intermediate switches are switched synchronously with one another, respectively.

6. The circuit arrangement according to claim 1, wherein a charging switch is connected in series upstream of the first inductive storage element.

7. The circuit arrangement according to claim 1, wherein a winding ratio (N₁/N₂) of windings (N₁) of the first inductive storage element to windings (N₂) of the second inductive storage element is greater than or equal to 1.

8. The circuit arrangement according to claim 1, wherein the first and second inputs are connected to at least one voltage measuring device.

9. The circuit arrangement according to claim 1, wherein the first inductive storage device and/or the second inductive storage device is connected to a voltage measuring device.

10. A battery management system comprising a circuit arrangement including:
a series connection of first and second battery units, wherein first and second battery units are arranged in an alternating manner;
a first inductive storage element; and
a second inductive storage element, which is inductively coupled to the first inductive storage element,
wherein in a primary phase, first inputs of the first battery units are connected to a first connector of the first inductive storage element via a first switch arrangement and second inputs of the second battery units are connected to a second connector of the first inductive storage element via the first switch arrangement, and
wherein in a secondary phase, using a second switch arrangement
a first connector of the second inductive storage element is connected to a first input of a first battery unit and a second connector of the second inductive storage element is connected to a second input of a second battery unit, or
a first connector of the second inductive storage element is connected to a second input of a second battery unit and a second connector of the second inductive unit is connected to a first input of a first battery unit according to one of the preceding claims.

11. The circuit arrangement according to claim 7, wherein the winding ratio (N₁/N₂) is between 1.05 and 1.5.

12. The circuit arrangement according to claim 11, wherein the winding ratio (N₁/N₂) is between 1.05 and 1.1.
